(19) United States
(12) Patent Application Publication
(10) Pub. No.: US 2020/0009817 A1
(43) Pub. Date: Jan. 9, 2020

(54) PRESS PLATENS HAVING FLUID-DRIVEN VARIABLE PRESSING SURFACE GEOMETRY AND RELATED METHODS

(71) Applicant: SABIC Global Technologies B.V., Bergen op Zoom (NL)

(72) Inventors: Theofanis THOFANOUS, Elsloo (NL); Roel VERLAEK, Elsloo (NL)

(21) Appl. No.: 16/494,921

(22) PCT Filed: Mar. 16, 2018
(86) PCT No.: PCT/IB2018/051777

§ 371 Date: Sep. 17, 2019

Related U.S. Application Data
(60) Provisional application No. 62/472,834, filed on Mar. 17, 2017.

(51) Int. Cl. B30B 15/06; B30B 5/02

(52) U.S. Cl. CPC B30B 15/064; B30B 5/02

(57) ABSTRACT

This disclosure includes platens for use in static presses, static presses including the same, and related methods. Some platens include a body (120) configured to be coupled to an actuator of a press and a plate (110) configured to be coupled to the body such that the plate defines at least a first portion of a pressing surface (140) of the platen, the pressing surface (140) configured to contact an object when the object is pressed by the platen, the plate and the body (120) cooperate to define a cavity (130) underlying the first portion of the pressing surface, at least one of the body and the plate define an inlet (190) in fluid communication with the cavity, and the first portion of the pressing surface is configured to deflect in response to pressure changes within the cavity (130).

### CROSS-REFERENCE TO RELATED APPLICATIONS

This application claims the benefit of priority of U.S. Provisional Patent Application No. 62/472,834 filed Mar. 17, 2017, which is hereby incorporated by reference in its entirety.

### BACKGROUND

### 1. Field of Invention

The present invention relates generally to presses, and more specifically, to press platens having fluid-driven variable pressing surface geometry and related methods.

### 2. Description of Related Art

To produce a laminate, a stack of one or more laminae can be consolidated by pressing the stack between heated pressing elements. Producing a laminate in this way is not without challenges. For example, when the stack is pressed, uneven pressing surface(s) of the pressing elements, uneven distributions of material (e.g., fibers and matrix material) within the lamina(e), and/or the like can result in an uneven distribution of pressure between the stack and the pressing elements, which may be exacerbated when the stack is thin. Such an uneven distribution of pressure can result in uneven distributions of material (e.g., fibers and matrix material), unpredictable structural characteristics, an uneven surface finish, and/or the like in the produced laminate.

### SUMMARY

Some embodiments of the present platens, via including a pressing surface and a cavity that underlies at least a portion of the pressing surface, where the pressing surface is configured to deflect in response to pressure changes within the cavity, can be configured to encourage an even application of pressure to an object when the object is pressed by the platen. In some embodiments, a heated or cooled fluid can be supplied to the cavity to heat or cool the pressing surface.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above, and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a schematic cross-sectional view of a first embodiment of the present platens that may be suitable for use in some embodiments of the present presses.

FIG. 2 is a schematic cross-sectional view of a second embodiment of the present platens that may be suitable for use in some embodiments of the present presses.

FIG. 3A is a schematic exploded view of a stack of laminae that can be pressed using embodiments of the present platens and/or presses.

FIG. 3B is a schematic view of a lamina that can be included in a stack of one or more laminae.

FIG. 4 is a schematic cross-sectional view of a first embodiment of the present presses, including two of the platens of FIG. 1.

FIG. 5 is a schematic cross-sectional side view of a second embodiment of the present presses, which is configured to press an object having and/or into a non-planar shape, using third and fourth embodiments of the present platens.

### DETAILED DESCRIPTION

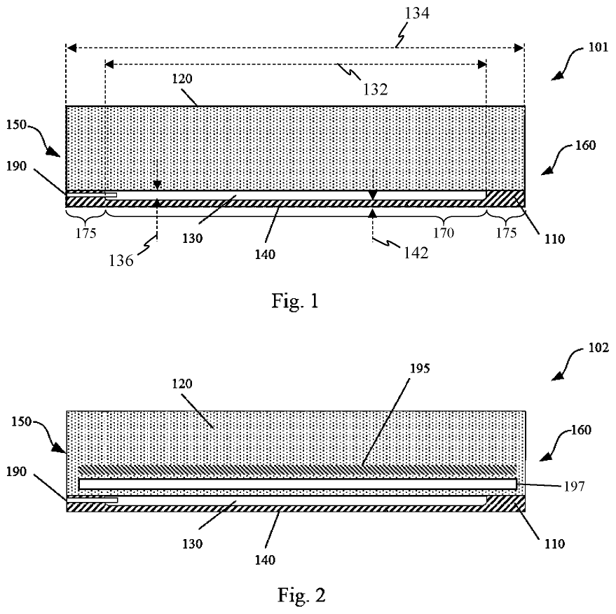

FIG. 1 depicts a first embodiment 101 of the present platens. Platen 101 can be used, for example, as one of a pair of opposing platens in a static press (e.g., 300, 500). For example, platen 101 includes a body 120 that can be coupled to one or more actuators (e.g., 450) of the press such that the actuator(s) can move the platen relative to the opposing platen in order to press an object (e.g., 310) that is disposed between the platens. Such a static press can be configured to apply heat to, remove heat from, apply pressure to, and/or relieve pressure from the object (e.g., 310), which can be, for example, a stack of one or more laminae (e.g., 200). Body 120 can comprise any suitable material, such as, for example, steel (e.g., stainless steel), aluminum, and/or the like.

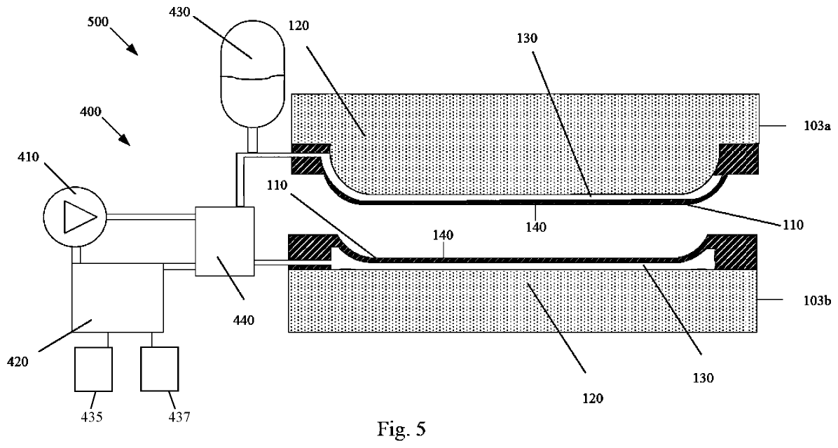

Platen 101 includes a plate 110 that can be coupled to body 120 such that the plate defines at least a first portion 170 of a pressing surface 140 of the platen, where the pressing surface is a surface that faces away from the body in order to contact an object (e.g., 310) when the object is pressed by the platen. First portion 170 can be a majority of pressing surface 140. When pressing surface 140 is in a non-deflected state (e.g., when pressure within cavity 130 is substantially equal to an ambient pressure) (described below), pressing surface 140 can be planar; however, in some platens, a pressing surface can include non-planar portion(s), such as, for example, convex and/or concave portion(s), when the pressing surface is in a non-deflected state (e.g., FIG. 5, pressing surfaces 140 of platens 103a and 103b).

When plate 110 is coupled to body 120, the plate and the body can cooperate to define a cavity 130 that underlies first portion 170 of pressing surface 140. For example, cavity 130 can be defined by at least a portion of each of plate 110 and body 120. A cavity (e.g., 130) of a platen (e.g., 101) can be said to “underlie” a portion of a pressing surface (e.g., 140) of the platen if the cavity is disposed vertically between the portion of the pressing surface and at least a portion of a body (e.g., 120) of the platen. Platen 110 includes an inlet 190 in fluid communication with cavity 130 to permit fluid to be supplied to and/or removed from the cavity. Inlet 190 can be defined by at least one of plate 110 and body 120.

First portion 170 of pressing surface 140 is configured to deflect in response to pressure changes within cavity 130. For example, first portion 170 can deflect outwardly (e.g., in a direction away from body 120) in response to an increase in pressure within cavity 130, and the first portion can deflect inwardly (e.g., in a direction toward body 120) in response to a decrease in pressure within the cavity. By varying pressure within cavity 130, first portion 170 of pressing surface 140 can be deflected to, for example, compensate for irregularities on and/or unevenness of the pressing surface, an object (e.g., 310) pressed by the pressing surface, and/or the like, encouraging an even application of pressure to the object by the pressing surface. The flexibility of first portion 170 of pressing surface 140 can be adjusted by varying pressure within cavity 130; for example, the first portion may be more flexible when pressure within the cavity is lower when compared to when pressure within the cavity is higher. Control over pressure within cavity 130 can be provided via a fluid delivery system (e.g., 400, described below) in fluid communication with the cavity.

Plate 110 can comprise a non-elastomeric material, i.e., a material that is not an elastomer. For example, plate 110 can comprise a metal material, such as, for example, steel (e.g., stainless steel), aluminum, copper, an alloy thereof, and/or the like. Such a metal material can provide for more controllable and/or smaller deflections of pressing surface 140 in response to pressure changes within cavity 130 when compared to an elastomeric material. Such a metal material can also increase the thermal conductivity of plate 110, facilitating the plate in transferring heat between fluid in cavity 130 and an object (e.g., 310) in contact with pressing surface 140. At least a portion of plate 110 can be relatively thin; for example, a portion of the plate that overlies cavity 130 can have a thickness 142 that is greater than or substantially equal to any one of, or between any two of: 0.10, 0.20, 0.25, 0.50, 0.75, 1.00, 1.25, 1.50, 1.75, 2.00, 2.25, 2.50, 2.75, 3.00, 3.25, 3.50, 3.75, 4.00, 4.25, 4.50, 4.75, or 5.00 millimeters (mm). A thickness (e.g., 142) of plate 110 can vary along the plate.

Cavity 130 can have any suitable dimensions. For example, cavity 130 can have a length 132 that is greater than or substantially equal to any one of, or between any two of: 20, 25, 30, 35, 40, 45, 50, 55, 60, 65, 70, 75, 80, 85, 90, 95, or more % of a length 134 of pressing surface 140. For further example, cavity 130 can have a height 136 that is greater than or substantially equal to any one of, or between any two of: 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, or 20.0 mm. For yet further example, cavity 130 can have a width, measured perpendicularly to both length 132 and height 136, that is greater than or substantially equal to any one of, or between any two of: 20, 25, 30, 35, 40, 45, 50, 55, 60, 65, 70, 75, 80, 85, 90, 95, or more % of a corresponding width of pressing surface 140. The width and/or height of the cavity can vary along its length, the width and/or length of the cavity can vary along its height, and/or the length and/or height of the cavity can vary along its width. Length 132, height 136, and the width of cavity 130 can be measured when pressing surface 140 is in a non-deflected state.

Plate 110 can be coupled to body 120 at a first end 150 of the body, a second end 160 of the body, and/or at any suitable location(s) along the body between its first and second ends. Coupling of plate 110 to body 120 can be achieved in any suitable fashion, such as, for example, via fastener(s) (e.g., bolt(s), screw(s), pin(s), rivet(s), and/or the like), welding, integral formation (e.g., in which at least a portion of the plate is unitary with at least a portion of the body), interlocking features of the plate and body, and/or the like. Plate 110 can be sealably coupled to body 120 to mitigate leakage of fluid from cavity 130. For example, one or more seals (e.g., gasket(s), O-ring(s), and/or the like), a sealant material, and/or the like can be disposed between the plate and the body, a seal can be formed by an interface between the plate and the body, and/or the like.

Pressing surface 140 can include a second portion 175 that does not overlie cavity 130. As shown, first portion 170 and second portion 175 of pressing surface 140 can be contiguous. When pressing surface 140 is in a non-deflected state, first portion 170 and second portion 175 can be coplanar. In platen 101, second portion 175 of pressing surface 140 is defined by plate 110; however, in other platens, such a second portion of a pressing surface can be defined by a body of the platen.

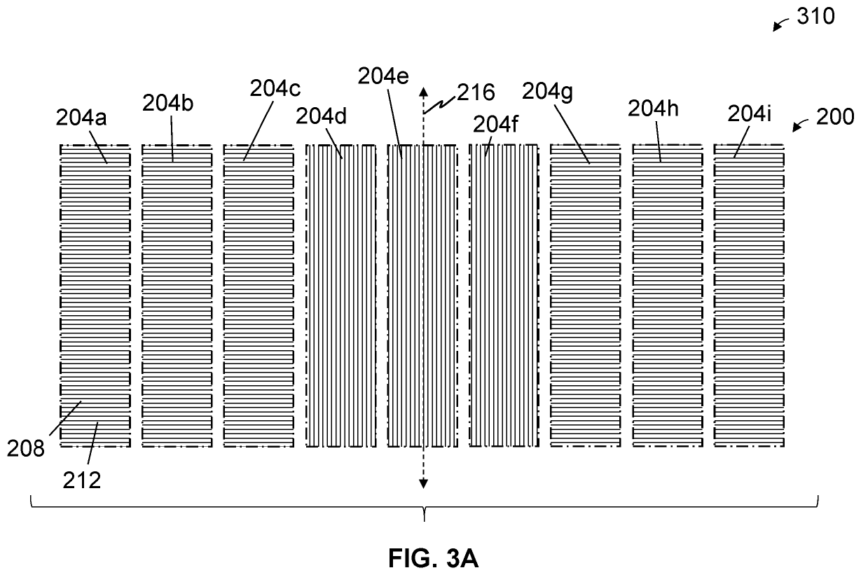

Referring now to FIG. 2, shown is a second embodiment 102 of the present platens. Platen 102 can be substantially similar to platen 101, with the primary exception that platen 102 includes an insulative material 195 (e.g., an insulative layer) and a chamber 197. Insulative material 195 can underlie at least a portion of cavity 130 in that the insulative material can be disposed vertically between the portion of the cavity and at least a portion of body 120. More particularly, insulative material 195 can underlie at least a majority of (up to and including all of) cavity 130. Insulative material 195 can comprise any suitable insulative material, such as, for example, polyurethane, polystyrene, polyimide, a rubber, a foam, and/or the like.

Chamber 197, which is not in fluid communication with cavity 130, can be at least partially filled with an insulative fluid, such as, for example air. Similarly to as described above for insulative material 195, chamber 197 can underlie at least a portion (up to and including a majority of or all of) cavity 130. In platens (e.g., 101) including both an insulative material (e.g., 195) and a chamber (e.g., 197), the insulative material can be disposed between the chamber and a cavity (e.g., 130) of the platen (e.g., FIG. 2), or the chamber can be disposed between the insulative material and the cavity. Some platens may comprise only one of an insulative material (e.g., 195) and a chamber (e.g., 197). Such an insulative material (e.g., 195) and/or a chamber (e.g., 197) can reduce heat transfer between fluid in a cavity (e.g., 130) of a platen (e.g., 102) and portions of the platen other than its pressing surface (e.g., 140), thereby improving efficiency.

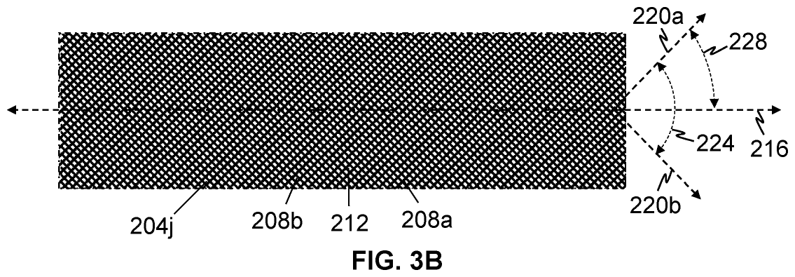

An object (e.g., 310) for pressing with the present platens and/or presses can comprise any suitable object. For example, FIG. 3A depicts a stack of one or more laminae 200—an exemplary object 310—that can be pre-heated, consolidated, and/or cooled using embodiments of the present platens and/or presses. Stack 200 includes nine laminae, 204a-204i; however, other stacks can include any suitable number of lamina(e), such as, for example, 1, 2, 3, 4, 5, 6, 7, 8, 9, 10, 11, 12, 13, 14, 15, or more lamina(e).

In stack 200, each of laminae 204a-204i includes fibers 208 dispersed within a matrix material 212. Fibers (e.g., 208) of a lamina (e.g., any of laminae 204a-204i) can include any suitable fibers, such as, for example, glass fibers, carbon fibers, aramid fibers, polyethylene fibers, polyester fibers, polyamide fibers, ceramic fibers, basalt fibers, steel fibers, and/or the like. A matrix material (e.g., 212) of a lamina (e.g., any of laminae 204a-204i) can include any suitable matrix material, such as, for example, a thermoplastic or thermoset matrix material. A suitable thermoplastic matrix material can include, for example, polyethylene terephthalate, polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polystyrene sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof. A suitable thermoset matrix material can include, for example, an unsaturated polyester resin, a polyurethane, bakelite, duroplast, urea-formaldehyde, diallyl-phthalate, epoxy resin, an epoxy vinylester, a polyimide, a cyanate ester of a polycyanurate, dicyclopentadiene, a phenolic, a benzoxazine, a co-polymer thereof, or a blend thereof. To illustrate, a lamina (e.g., any of laminae 204a-204i) including fibers (e.g., 208) can have a pre-consolidation fiber volume fraction that is greater than or substantially equal to any one of, or between any two of: 40, 45, 50, 55, 60, 65, 70, 75, 80, 85, or 90%.

In stack 200, each of laminae 204a-204i is a unidirectional lamina, or a lamina having fibers 208, substantially all of which are aligned with a single direction. As used herein, “aligned with” means within 10 degrees of parallel to. More particularly, in each of the laminae, the fibers are either aligned with a long dimension of the stack (e.g., measured in direction 216) (e.g., laminae 204d-204f, each of which may be characterized as a 0-degree unidirectional lamina) or are aligned with a direction that is perpendicular to the long dimension of the stack (e.g., laminae 204a-204c and laminae 204g-204i, each of which may be characterized as a 90-degree unidirectional lamina). Some stacks can include unidirectional lamina(e) that each have fibers (e.g., 208) that are aligned with any suitable direction, such as, for example, a direction that is angularly disposed relative to a long dimension of the stack at an angle that is greater than or substantially equal to any one of, or between any two of: 0, 5, 10, 15, 20, 25, 30, 35, 40, 45, 50, 55, 60, 65, 70, 75, 80, 85, or 90 degrees.

Some stacks can include lamina(e) having fibers (e.g., 208) arranged in a woven configuration (e.g., as in a lamina having a plane, twill, satin, basket, leno, mock leno, or the like weave). Referring additionally to FIG. 3B, lamina 204j, which can be included in a stack, can include a first set of fibers 208a aligned with a first direction 220a and a second set of fibers 208b aligned with a second direction 220b that is angularly disposed relative to the first direction, where the first set of fibers is woven with the second set of fibers. A smallest angle 224 between first direction 220a and second direction 220b can be greater than or substantially equal to any one of, or between any two of: 5, 10, 15, 20, 25, 30, 35, 40, 45, 50, 55, 60, 65, 70, 75, 80, 85, or 90 degrees. A smallest angle 228 between first direction 220a and a long dimension of a stack including lamina 204j (e.g., measured in direction 216) can be greater than or substantially equal to any one of, or between any two of: 0, 5, 10, 15, 20, 25, 30, 35, 40, 45, 50, 55, 60, 65, 70, 75, 80, 85, or 90 degrees.

In stack 200, laminae 204a-204i are arranged in a 90, 90, 90, 0, 0, 0, 90, 90, 90 lay-up. Other stacks can include any suitable lamina(e), including one or more of any lamina described above, arranged in any suitable lay-up, whether symmetric or asymmetric.

Some stacks can include sheet(s), film(s), core(s) (e.g., porous, non-porous, honeycomb, and/or the like core(s)), and/or the like. Such sheet(s), film(s), and/or core(s) may or may not comprise fibers (e.g., 208) and can comprise any material described above as a matrix material (e.g., 212).

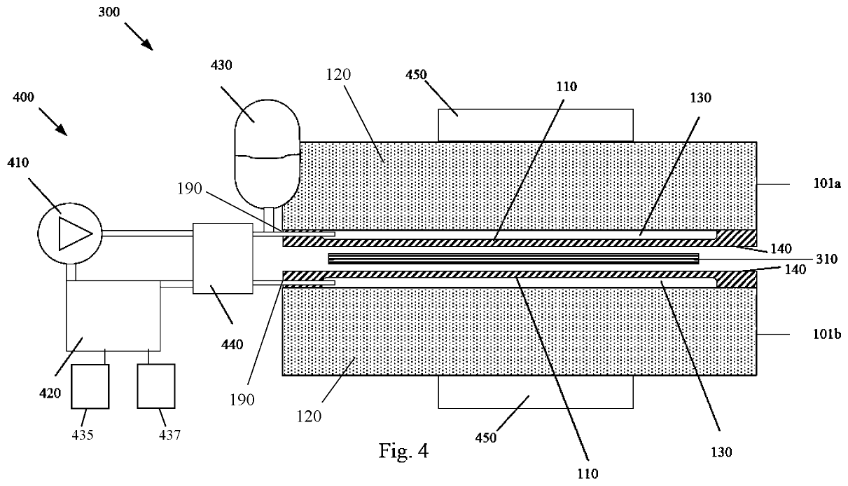

Referring to FIG. 4, shown is a first embodiment 300 of the present static presses.

Press 300 can include a first, upper platen 101a and an opposing second, lower platen 101b, one or both of which can be a platen 101. In some presses, only one of the platens includes a plate (e.g., 110) and a cavity (e.g., 130), and the other of the platens can be a conventional platen. First platen 101a and second platen 101b can each be coupled to one or more actuators 450 configured to reduce a distance between pressing surfaces 140 of the platens and thereby press an object (e.g., 310) between the pressing surfaces. Actuator(s) 450 can comprise any suitable actuator, such as, for example, a hydraulic, pneumatic, electric, and/or the like actuator.

Cavity 130 of first platen 101a and cavity 130 of second platen 101b can be in fluid communication with one or more fluid delivery systems 400 to permit fluid to be supplied to and/or removed from the cavities. Such a fluid can be one that is regarded as an incompressible fluid, such as, for example, water, an oil-based fluid, and/or the like. Such a fluid can be a compressible fluid, such as, for example, air, another gas, and/or the like. As shown, both cavity 130 of first platen 101a and cavity 130 of second platen 101b can be in fluid communication with a single fluid delivery system 400. In some embodiments, a cavity (e.g., 130) of a first platen (e.g., 101a) can be in fluid communication with a first fluid delivery system (e.g., 400), and a cavity (e.g., 130) of a second platen (e.g., 101b) can be in fluid communication with a second fluid delivery system (e.g., 400). In some embodiments, a cavity (e.g., 130) of a first platen (e.g., 101a) can be in fluid communication with a cavity (e.g., 130) of a second platen (e.g., 101b) (e.g., via a conduit therebetween).

Fluid delivery system 400 can include one or more pressure sources configured to be in fluid communication with a cavity (e.g., 130) of a platen (e.g., 101a) such that the pressure source(s) can be used to increase pressure within, and, in some instances, decrease pressure within, the cavity. For example, fluid delivery system 400 can comprise a pump 410, which can be used to increase and/or decrease pressure within the cavity (e.g., the pump can comprise a bi-directional pump). Fluid for use with pump 410 (and/or other(s) of the pressure source(s)) can be supplied from a reservoir 420.

For further example, fluid delivery system 400 can comprise an accumulator 430. By enabling fluid communication between accumulator 430 and the cavity, the cavity can be pressurized and/or depressurized. For example, if pressure within the accumulator is greater than pressure within the cavity, pressure within the cavity can be increased, and, if pressure within the accumulator is lower than pressure within the cavity, pressure within the cavity can be decreased. In some instances, accumulator 430 can be pressurized by pump 410. While accumulator 430 is in fluid communication with the cavity, the accumulator can, via its ability to absorb energy, increase the flexibility of a pressing surface (e.g., 140) of the platen. Accumulator 430 can comprise any suitable accumulator, such as, for example, a piston-type, bladder-type, and/or the like accumulator.

Fluid delivery system 400 can include a reservoir 420 configured to supply fluid to the pressure source(s). In some instances, fluid communication between the cavity and reservoir 420 can be enabled to, for example, lower pressure within the cavity. Fluid delivery system 400 can include one or more valves (e.g., 440) configured to control fluid communication between component(s) of the fluid delivery system (e.g., the pressure source(s), reservoir 420, and/or the like) and/or component(s) of the platen and/or the other platen (e.g., the cavity, a cavity 130 of the other platen, and/or the like).

Fluid delivery system 400 can be configured to provide heated and/or cooled fluid to the cavity. For example, such fluid can be heated and/or cooled in reservoir 420 via, for example, a heating source 435 (e.g., a heating element) coupled to the reservoir, a cooling source 437 coupled to the reservoir, and/or the like. In some embodiments, separate reservoirs can be provided for heated and cooled fluid. In some embodiments, such fluid can be heated and/or cooled by passing the fluid through a heat exchanger. To illustrate, such heated fluid can be at a temperature that is greater than or substantially equal to any one of, or between any two of: 140, 150, 160, 170, 180, 190, 200, 210, 220, 230, 240, 250, 260, 270, 280, 290, 300, 310, 320, 330, 340, 350, 360, 370, 380, 390, or 400° C. To further illustrate, such cooled fluid can be at a temperature that is less than or substantially equal to any one of, or between any two of: 10, 15, 20, 25, 30, 35, 40, 45, or 50° C. (e.g., approximately room temperature). In at least these ways, fluid delivery system 400 can be configured to vary a temperature of the pressing surface and thus an object (e.g., 310) pressed by the pressing surface.

Referring to FIG. 5, shown is a second embodiment 500 of the present static presses. Static press 500 can include a first, upper platen 103a and an opposing second, lower platen 103b. For example, one or both of first platen 103a and second platen 103b can be substantially similar to platen 101, with the primary exception that pressing surface 140 of first platen 103a and pressing surface 140 of second platen 101b comprise a curved portion that is configured to correspond to a desired surface shape of an object (e.g., 310) pressed by press 500. As shown, pressing surface 140 of first platen 103a includes a curved portion that is at least partially convex and pressing surface 140 of second platen 103b includes a corresponding curved portion that is at least partially concave. In some embodiments, a pressing surface (e.g., 140) of a first platen (e.g., 103a) includes a curved portion that is at least partially concave and a pressing surface (e.g., 140) of a second platen (e.g., 103b) includes a corresponding curved portion that is at least partially convex. It will be appreciated that other curvatures are possible for pressing surface 140 of one or both of first platen 103a and second platen 103b.

Some embodiments of the present methods for pressing an object comprise disposing an object (e.g., 310) between a first platen (e.g., 101, 101a, 102, 103a) and a second platen (e.g., 101, 101b, 102, 103b) of a press (e.g., 300, 500), each of the platens having a pressing surface (e.g., 140), at least one of the platens comprising a body (e.g., 120) and a plate (e.g., 110) that defines at least a first portion (e.g., 170) of the pressing surface of the platen, the plate and the body cooperating to define a cavity (e.g., 130) underlying the first portion of the pressing surface, moving the platens relative to each other to press the object between the pressing surfaces, and, for at least one of the platens, pressurizing the cavity to deflect the first portion of the pressing surface, thereby varying a pressure applied to the object by the pressing surface. In some embodiments of the present methods, for at least one of the platens, the plate comprises a non-elastomeric material, and, optionally, the non-elastomeric material comprises metal. In some embodiments of the present methods, for at least one of the platens, the pressing surface includes a second portion (e.g., 175) that does not overlie the cavity, and the first portion and the second portion are coplanar.

Some embodiments of the present methods comprise, for at least one of the platens, heating the pressing surface at least by supplying a heated fluid to the cavity, the heated fluid optionally having a temperature of between approximately 140° C. and approximately 320° C.; and/or cooling the pressing surface at least by supplying a cooled fluid to the cavity, the cooled fluid optionally having a temperature of between approximately 25° C. and approximately 30° C.

Some embodiments of the present platens for use in a static press comprise: a body configured to be coupled to an actuator of a press, and a plate configured to be coupled to the body such that the plate defines at least a first portion of a pressing surface of the platen, the pressing surface configured to contact an object when the object is pressed by the platen, the plate and the body cooperate to define a cavity underlying the first portion of the pressing surface, at least one of the body and the plate define an inlet in fluid communication with the cavity, and the first portion of the pressing surface is configured to deflect in response to pressure changes within the cavity.

In some platens, the plate comprises a non-elastomeric material, and, optionally, the non-elastomeric material comprises metal. In some platens, the plate is removably coupled to the body.

In some platens, the cavity underlies at least a majority of the pressing surface. In some platens, the pressing surface includes a second portion that does not overlie the cavity, and the first portion and the second portion are coplanar. In some platens, at least a portion of the pressing surface is concave and/or at least a portion of the pressing surface is convex.

Some platens comprise a thermally-insulative material disposed between the cavity and at least a portion of the body. In some platens, the body defines a chamber that underlies at least a portion of the cavity and is not in fluid communication with the cavity.

Some embodiments of the present static presses comprise: first and second platens, each having a pressing surface, and at least one actuator configured to reduce a distance between the platens to press an object with the pressing surfaces when the object is disposed between the platens, wherein at least one of the platens includes a body and a plate configured to be coupled to the body such that the plate defines at least a first portion of the pressing surface of the platen, the plate and the body cooperate to define a cavity underlying the first portion of the pressing surface, at least one of the body and the plate define an inlet in fluid communication with the cavity, and the first portion of the pressing surface is configured to deflect in response to pressure changes within the cavity.

In some presses, for at least one of the platens, the plate comprises a non-elastomeric material, and, optionally, the non-elastomeric material comprises metal. In some presses, for at least one of the platens, the pressing surface includes a second portion that does not overlie the cavity, and the first portion and the second portion are coplanar. In some presses, at least one of the platens includes a thermally-insulative material disposed between the cavity and at least a portion of the body.

Some presses comprise a fluid delivery system in fluid communication with the inlet of at least one of the platens, the fluid delivery system configured to vary a pressure within the cavity of the at least one platen. In some presses, the fluid delivery system comprises a pressure source including a pump and/or an accumulator. In some presses, the fluid delivery system comprises a valve configured to control fluid communication between the pressure source and the cavity of the at least one platen.

Some embodiments of the pressing methods for pressing an object comprise: disposing an object between first and second platens of a press, each of the platens having a pressing surface, at least one of the platens comprising a body and a plate that defines at least a first portion of the pressing surface of the platen, the plate and the body cooperating to define a cavity underlying the first portion of the pressing surface, moving the platens relative to each other to press the object between the pressing surfaces, and, for at least one of the platens, pressurizing the cavity to deflect the first portion of the pressing surface, thereby varying a pressure applied to the object by the pressing surface.

In some methods, for at least one of the platens, the plate comprises a non-elastomeric material, and, optionally, the non-elastomeric material comprises metal. In some methods, for at least one of the platens, the pressing surface includes a second portion that does not overlie the cavity, and the first portion and the second portion are coplanar.

Some methods comprise, for at least one of the platens, heating the pressing surface at least by supplying a heated fluid to the cavity, the heated fluid optionally having a temperature of between approximately 140° C. and approximately 400° C., and/or cooling the pressing surface at least by supplying a cooled fluid to the cavity, the cooled fluid optionally having a temperature of between approximately 25° C. and approximately 30° C.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A platen for use in a static press, the platen comprising:
a body configured to be coupled to an actuator of a press; and
a plate configured to be coupled to the body such that:
the plate defines at least a first portion of a pressing surface of the platen, the pressing surface configured to contact an object when the object is pressed by the platen;
the plate and the body cooperate to define a cavity underlying the first portion of the pressing surface;
at least one of the body and the plate define an inlet in fluid communication with the cavity; and
the first portion of the pressing surface is configured to deflect in response to pressure changes within the cavity.

2. The platen of claim 1, wherein:
the plate comprises a non-elastomeric material; and
optionally, the non-elastomeric material comprises metal.

3. The platen of claim 1 or 2, wherein:
the pressing surface includes a second portion that does not overlie the cavity; and
the first portion and the second portion are coplanar.

4. The platen of claim 1 or 2, wherein at least a portion of the pressing surface is concave and/or at least a portion of the pressing surface is convex.

5. The platen of claim 1 or 2, wherein the plate is removably coupled to the body.

6. The platen of claim 3, wherein the cavity underlies at least a majority of the pressing surface.

7. The platen of claim 1 or 2, comprising a thermally-insulative material disposed between the cavity and at least a portion of the body.

8. The platen of claim 1 or 2, wherein the body defines a chamber that underlies at least a portion of the cavity and is not in fluid communication with the cavity.

9. A static press comprising:
first and second platens, each having a pressing surface; and
at least one actuator configured to reduce a distance between the platens to press an object with the pressing surfaces when the object is disposed between the platens;
wherein at least one of the platens includes:
a body; and
a plate configured to be coupled to the body such that:
the plate defines at least a first portion of the pressing surface of the platen;
the plate and the body cooperate to define a cavity underlying the first portion of the pressing surface;
at least one of the body and the plate define an inlet in fluid communication with the cavity; and
the first portion of the pressing surface is configured to deflect in response to pressure changes within the cavity.

10. The static press of claim 9, wherein, for at least one of the platens:
the plate comprises a non-elastomeric material; and
optionally, the non-elastomeric material comprises metal.

11. The static press of claim 9 or 10, wherein, for at least one of the platens:
the pressing surface includes a second portion that does not overlie the cavity; and
the first portion and the second portion are coplanar.

12. The static press of claim 9 or 10, wherein at least one of the platens includes a thermally-insulative material disposed between the cavity and at least a portion of the body.

13. The static press of claim 9 or 10, comprising a fluid delivery system in fluid communication with the inlet of at least one of the platens, the fluid delivery system configured to vary a pressure within the cavity of the at least one platen.

14. The static press of claim 13, wherein the fluid delivery system comprises a pressure source including a pump and/or an accumulator.

15. The static press of claim 14, wherein the fluid delivery system comprises a valve configured to control fluid communication between the pressure source and the cavity of the at least one platen.

16. A method for pressing an object, the method comprising:
disposing an object between first and second platens of a press, each of the platens having a pressing surface, at least one of the platens comprising:
a body; and
a plate that defines at least a first portion of the pressing surface of the platen, the plate and the body cooperating to define a cavity underlying the first portion of the pressing surface;
moving the platens relative to each other to press the object between the pressing surfaces; and
for at least one of the platens, pressurizing the cavity to deflect the first portion of the pressing surface, thereby varying a pressure applied to the object by the pressing surface.

17. The method of claim 16, wherein, for at least one of the platens:
the plate comprises a non-elastomeric material; and
optionally, the non-elastomeric material comprises metal.

18. The method of claim 16 or 17, wherein, for at least one of the platens:
the pressing surface includes a second portion that does not overlie the cavity; and
the first portion and the second portion are coplanar.

19. The method of claim 16 or 17, comprising, for at least one of the platens:
heating the pressing surface at least by supplying a heated fluid to the cavity, the heated fluid optionally having a temperature of between approximately 140° C. and approximately 400° C.; and/or
cooling the pressing surface at least by supplying a cooled fluid to the cavity, the cooled fluid optionally having a temperature of between approximately 25° C. and approximately 30° C.
